(19) United States
(12) Patent Application Publication
(10) Pub. No.: US 2019/0287146 A1
(43) Pub. Date: Sep. 19, 2019

(54) SYSTEM, METHOD, AND COMPUTER PROGRAM FOR IMPLEMENTING A LICENSE LEDGER IN A NETWORK FUNCTION VIRTUALIZATION (NFV) BASED COMMUNICATION NETWORK

(71) Applicant: Amdocs Development Limited, Limassol (CY)

(72) Inventors: Roger James Maitland, Woodlawn (CA); Gad Yitzhak Weissman, Hod HaSharon (IL)

(21) Appl. No.: 15/379,372

(22) Filed: Dec. 14, 2016

(51) Int. Cl. G06Q 30/04

(52) U.S. Cl. CPC G06Q 30/04; G06Q 2220/18

(57) ABSTRACT

A system, method, and computer program product are provided for implementing a license ledger in a Network Function Virtualization based (NFV-based) communication network. In operation, a license ledger system identifies information corresponding to one or more usage transactions associated with one or more virtual network functions (VNFs) in a NFV-based network. The license ledger system stores the information associated with the one or more usage transactions utilizing blockchain technology such that the information associated with the one or more usage transactions is unalterable. Additionally, the license ledger system communicates with one or more license reporters to provide access to usage data corresponding to the one or more usage transactions associated with the one or more VNFs to provide a trusted source for real-time usage data.

### FIELD OF THE INVENTION

The present invention relates to telecommunications and/or data communications and, more particularly to network function virtualization (NFV) of telecommunications networks.

### BACKGROUND

Network Function Virtualization is a term or a name of a proposed architecture of telecom services as published by the European Telecommunications Standards Institute (ETSI) in a series of documents available from the ETSI website. NFV uses generic hardware platform and software adapted for the generic hardware platform. Thus, NFV creates a network much more flexible and dynamic than a legacy communication network. In NFV-based networks, a Virtual Network Function (VNF) decouples the software implementation of the network function from the infrastructure resources it runs on by virtualization. A network service is based on one or more VNFs and/or Physical Network Functions (PNFs), their interconnections, and chaining definitions. The VNFs can be executed on almost any generic hardware processing facility. Therefore, VNFs may be installed, removed, and moved between hardware facilities, much more easily, less costly and thus, more frequently.

Telecom Network Operators are moving to NFV-based networks where rapid on-boarding of vendor provided VNFs raises difficult questions about usage licenses. Operators are interested in eliminating vendor provided license servers and simplifying the overall license process. Vendors are now in a situation where VNF usage is controlled and monitored by the operator without an independent mechanism for usage verification.

There is thus a need for addressing these and/or other issues associated with the prior art.

### SUMMARY

A system, method, and computer program product are provided for implementing a license ledger in a Network Function Virtualization based (NFV-based) communication network. In operation, a license ledger system identifies information corresponding to one or more usage transactions associated with one or more virtual network functions (VNFs) in a NFV-based network. The license ledger system stores the information associated with the one or more usage transactions utilizing blockchain technology such that the information associated with the one or more usage transactions is unalterable. Additionally, the license ledger system communicates with one or more license reporters to provide access to usage data corresponding to the one or more usage transactions associated with the one or more VNFs to provide a trusted source for real-time usage data.

### BRIEF DESCRIPTION OF THE DRAWINGS

FIG. 1 illustrates a method for implementing a license ledger in a NFV-based communication network, in accordance with one embodiment.

FIG. 2 illustrates a simplified diagram of a system associated with a NFV-based communication network, in accordance with one embodiment.

FIG. 3 illustrates a simplified block diagram of a hardware unit of a NFV-based network, in accordance with one embodiment.

FIG. 4 illustrates a simplified diagram of a NFV management system, in accordance with one embodiment.

FIG. 5 illustrates a simplified diagram of a deployed NFV-based network, in accordance with one embodiment.

FIG. 6 illustrates a simplified diagram of a license ledger system architecture, in accordance with one embodiment.

FIG. 7 illustrates a simplified diagram of two license ledger usage models, in accordance with one embodiment.

FIG. 8 illustrates a network architecture, in accordance with one possible embodiment.

FIG. 9 illustrates an exemplary system, in accordance with one embodiment.

### DETAILED DESCRIPTION

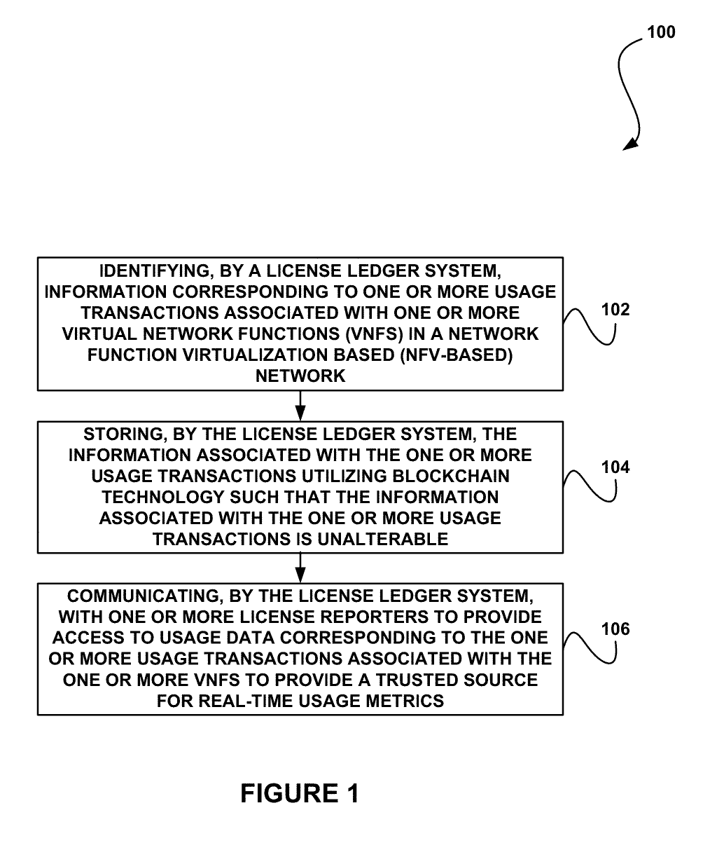

FIG. 1 illustrates a method 100 for implementing a license ledger in a NFV-based communication network, in accordance with one embodiment.

As shown, a license ledger system identifies information corresponding to one or more usage transactions associated with one or more virtual network functions (VNFs) in a NFV-based network. See operation 102.

The license ledger system stores the information associated with the usage transactions utilizing blockchain technology such that the information is unalterable. See operation 104.

Additionally, the license ledger system communicates with one or more license reporters to provide access to usage data corresponding to the usage transactions associated with the VNFs to provide a trusted source for real-time usage data. See operation 106.

In various embodiments, the information corresponding to the usage transactions may include metrics and life-cycle events associated with the VNFs or pointers to the metrics and/or life-cycle events. For example, identifying the information associated with the usage transactions may include receiving and storing the usage transactions (e.g. the metrics and life-cycle events, etc.). As another example, identifying the information associated with the usage transactions may include recording one or more pointers to the usage transactions (e.g. the metrics and life-cycle events, etc.). In this case, the usage transactions may be stored in a secure database.

Each of the VNFs may include a license agent incorporated therein. The license agent may include computer code that functions as an application programming interface (API) capable of communicating with the license ledger system. In one embodiment, each of the license agents may have a communication link to the license ledger system utilizing a secure HTTPS protocol. Of course, the license agents may have a communication link to the license ledger system utilizing any secure protocol, depending on desires of the implementer. Further, each of the license agents may send the usage transaction information, such as metrics and life-cycle events, to the license ledger system. Additionally, each of the license agents may communicate data associated with a corresponding VNF including a license identifier associated with the corresponding VNF, operator and vendor identifiers associated with the corresponding VNF, and dates and times, etc.

Each of the license agents may also communicate usage metrics associated with a corresponding VNF, including metrics such as a number of active subscribers being hosted by the corresponding VNF, a number of active sessions associated with the corresponding VNF, bandwidth use information associated with the corresponding VNF, a packet rate associated with the corresponding VNF, a number of ports associated with the corresponding VNF, a number of links associated with the corresponding VNF, a number of VPNs (virtual private networks) associated with the corresponding VNF, a number of routes associated with the corresponding VNF, a VNFC instance (VM or container) associated with the corresponding VNF, memory usage associated with the corresponding VNF, CPU consumption associated with the corresponding VNF, a number of vCPUs associated with the corresponding VNF, a disk access rate associated with the corresponding VNF, storage volume associated with the corresponding VNF, a number of subtending clients or devices associated with the corresponding VNF, a number of database tables associated with the corresponding VNF, and/or various other metrics, etc. Still yet, each of the license agents may communicate life-cycle events associated with a corresponding VNF including VNF creation information, VNF deletion information, VNF scaling information, and VNF failure information, etc.

In one embodiment, the license reporters may be an application residing on a vendor and/or operator system (e.g. a web accessible application including a user interface, etc.). The license reporters allow operators and vendors to access the usage data associated with the one or more usage transactions. The usage data may include the actual usage transactions reported by the license agents, such as the metrics and life-cycle events, and/or reports and/or details associated with the usage transactions. For example, in one embodiment, actual usage transaction data may need to be summarized for readability and/or edited to remove confidential information (e.g. associated with a competitor, etc.). In one embodiment, the license reporters may provide a view of a subset of the data in the license ledger (i.e. vendors may only see usage transactions for the VNFs they provide, etc.).

In either case, the license reporters will allow operators and vendors to access usage data stored by the license ledger system (or accessible by the license ledger using pointers) as a trusted source for real-time usage metrics. This trusted source for real-time usage metrics may be used for a wide range of operations, including generating billing models for use of the VNFs, generating billing records for use of the VNFs, auditing of usage of the VNFs, and various other operations.

This trust is enabled because the license ledger system utilizes blockchain technology to store the information. In various embodiments, the license ledger system may be included in the NFV-based network including the VNFs or may be operated outside of the NFV-based network (e.g. operated by a third party, etc.).

It should be noted that the method 100 may be implemented utilizing various systems, hardware, software, applications, VNFs, user interfaces, etc., as dictated by the implementer. For example, in various embodiments, the license ledger system may include one or more processors, databases (e.g. distributed databases, etc.), etc., as well as implement various logic, computer code, applications, and/or user interfaces, etc.

In one embodiment, the license ledger system may be a VNF, chain of VNFs, and/or include one or more VNFs.

Blockchain technology refers to technology that utilizes a distributed database that maintains a continuously-growing list of records called blocks. Each block may contain a timestamp and a link to a previous block. The data in a block cannot be altered retrospectively. Blockchain technology is an example of a distributed computing system with high byzantine fault tolerance.

In the context of the present description, the terms “network” and “communication network” refer to the hardware and software connecting one or more communication elements including wireline networks, wireless networks, and/or combinations thereof.

The terms “network function virtualization” (NFV) and virtual network function (VNF) are described in a series of documents published by the European Telecommunications Standards Institute (ETSI) and available from the ETSI website. The term “virtual network function or feature” (VNF) refers to a particular implementation of a function, a feature, or a service provided by the network, internally within the network, or externally to a customer, subscriber, end-user, a terminal or a server. A VNF may include the software program implementation of the function or feature or service. The term VNF instance (VNF-I) refers to a particular process or task executing the VNF program by a particular virtual machine or processor or computing facility and/or used by a particular customer (or subscriber, end-user, terminal or server, etc.).

The term “service” refers to any type of use (such as a use case) that a NFV-based communication network may offer or provide to one or more communication elements. A service may include switching data or content between any number of elements, providing content from a server to a communication element or between servers, securing and protecting communication and content, processing content provided by the customer or by a third party, providing backup and redundancy, etc. A service may be using partial functionality of a VNF or may include one or more VNFs and/or one or more VNF instances forming a service sub-network (or interconnection model). In the context of the present description, the term “chain” may refer to such service sub-network, such as a particular plurality of VNFs and/or VNF instances associated with a particular service type or a service instance.

The term “deployment”, when referring to hardware elements, including processing elements, memory elements, storage elements, connectivity (communication) elements, etc., refer to the configuration or topology of these hardware elements creating the NFV-based network. The term “deployment”, when referring to software elements, such a VNFs and VNF instances, refers to the association between such software elements and hardware elements.

The term “deployment optimizations” refers to association of software and hardware elements in a manner that satisfies a particular set of requirements and/or rules, such as load-related and performance-related requirements, or a manner that makes a better use of a particular hardware deployment, such as by reducing operational cost.

The terms “service deployment optimization”, or “service optimization” or “chain optimization” refer to optimizing the deployment of a service chain, i.e., optimizing the deployment of one or more VNF instances making a particular service. The terms chain optimization and service optimization may thus be used interchangeably.

The term “session” refers to a communication connection between two or more entities that persists for a period of time during which data may be exchanged there between. A session may be implemented and managed by a session layer in the corresponding network protocol. The term session may include a network session and a logical session. The network session may be associated with the devices used to communicate, while the logical session may be associated with the communicating parties (users) and may persist regardless of the communication means that the parties are using.

The term “service continuity” includes and applies to the terms “session continuity” and “streaming continuity”. Streaming refers to streaming media, session or service, such as sound (including voice), video, multimedia, animation, etc. The term service usually applies to a group of VNFs (or the functionality provided by the group of VNFs) but may also apply to a single VNF (or the functionality provided by the VNF). The term “continuity” indicates that the session or the service is not interrupted, or that an interruption is short enough that a user is not aware of such interruption, or that the interruption does not cause any loss of data, or that the loss is handled in acceptable manner (e.g. a few packets of speech lost, but the conversation can continue, etc.).

The term “availability” or “service availability” refers to a level of the service, or a characteristic of the service, in which the service provider should provide the service, albeit possible hardware or software faults. For example, the service provider may obligate to the customer to provide a particular level of processing power, communication features such as bandwidth, latency, and jitter, database consistency, etc. Such level or characteristic of the service should be available to the customer even when a hardware component or a software component providing the service do not function properly. Providing availability may therefore require additional resources such as backup resources and/or mirroring. Hence “availability” may also refer to the terms “fault recovery” and “redundancy”.

The term “fault recovery” refers to the process of recovering one or more of the network's services, functions, and features after a fault, whether caused by a hardware malfunction, a system crash, a software bug or a security breech or fault. A hardware malfunction includes, but is not limited to, any type of inadequate performance associated with, for example, power supply, processing units, memory, storage, transmission line, etc. The term “fault recovery” also applies to recovering the functionality of one or more VNFs or VNF instances with respect to any of the above. The terms security breech or security fault may be used interchangeably.

The term “redundancy” refers to any type of component of the network that is fully or partly duplicated, provided in standby mode, or otherwise available, to replace another component of the network when that other component stops functioning properly or otherwise indicates some kind of fault. Redundancy may apply, but is not limited to, hardware, software, data and/or content.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

The principles and operation of a system, method, and computer program product for implementing a license ledger according to various embodiments may be further understood with reference to the following drawings and accompanying description.

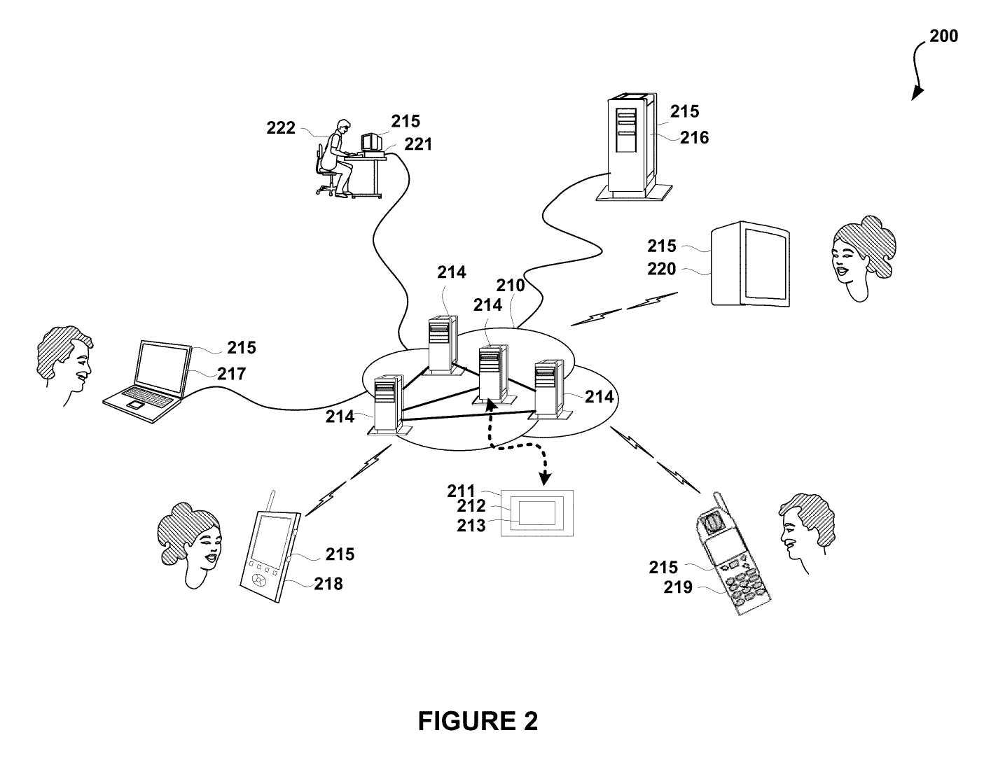

FIG. 2 illustrates a simplified diagram of a system 200 associated with an NFV-based communication network 210, in accordance with one embodiment. As an option, the system 200 may be implemented in the context of the details of FIG. 1. Of course, however, system 200 may be implemented in the context of any desired environment. Further, the aforementioned definitions may equally apply to the description below.

As shown in FIG. 2, at least one NFV-based network 210 is provided. The NFV-based communication network 210 includes an NFV management system 2111, an NFV-orchestration (NFV-O) module 212, and a license ledger module 213, according to one embodiment.

In the context of the present network architecture, the NFV-based network 210 may take any form including, but not limited to a telecommunications network, a local area network (LAN), a wireless network, a wide area network (WAN) such as the Internet, peer-to-peer network, cable network, etc. While only one network is shown, it should be understood that two or more similar or different NFV-based networks 210 may be provided.

The NFV-based network 210 may include one or more computation facilities 214, each including one or more hardware units and being interconnected by communication links to form the NFV-based network 210. At least one of the computation facilities 214 may include the NFV management system 211. The NFV management system 211 may include the NFV-O module 212 and the license ledger module 213.

The NFV-O module 212 may be executed by one or more processors, or servers, such as computation facilities 214, of the NFV-based network 210. The NFV-O module 212 may be executed as an NFV-O instance or component. The NFV-O module 212 may therefore include a plurality of NFV-O instances or components as will be further explained below.

The license ledger module 213 may be a part or a component of the NFV-O module 212. However, the license ledger module 213, the NFV-O module 212 and the NFV management system 211 may be separate software programs provided by different vendors. In one embodiment, the NFV-based network 210 may even have a plurality of any of the NFV management systems 211, the NFV-O modules 212, and/or the license ledger modules 213.

A plurality of devices 215 are communicatively coupled to the NFV-based network 210. For example, a server computer 216 and a computer or terminal 217 may be coupled to the NFV-based network 210 for communication purposes. Such end-user computer or terminal 217 may include a desktop computer, a lap-top computer, a tablet computer, and/or any other type of logic or data processing device. Still yet, various other devices may be coupled to the NFV-based network 210 including a personal digital assistant (PDA) device 218, a mobile phone device 219, a television 220 (e.g. cable, aerial, mobile, or satellite television, etc.) 2, etc. These devices 215 may be owned and/or operated by end-users, subscribers and/or customers of the NFV-based network 210. Others of the devices 215, such as administration station 221, may be owned and/or operated by the operator of the NFV-based network 210.

A network administrator 222 may supervise at least some aspects of the operation of the NFV-based network 210 by controlling an NFV infrastructure including the NFV management system 211, the NFV-O 212, and the license ledger module 213.

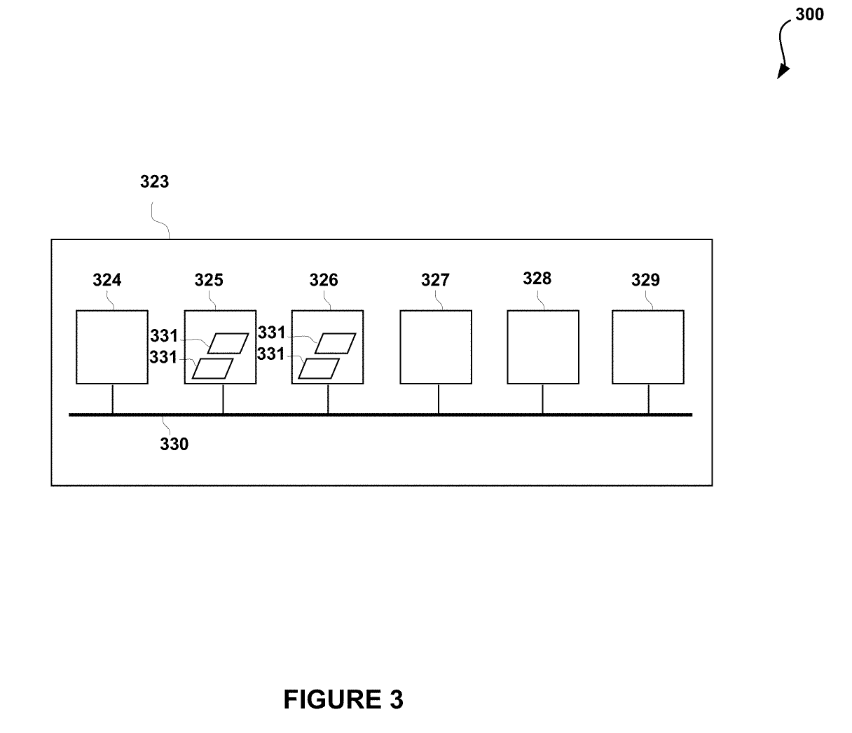

FIG. 3 illustrates a simplified block diagram 300 of a hardware unit 323 of an NFV-based network, in accordance with one embodiment. As an option, the block diagram 300 may be viewed in the context of the details of the previous Figures. Of course, however, block diagram 300 may be viewed in the context of any desired environment. Further, the aforementioned definitions may equally apply to the description below.

In one embodiment, the hardware unit 323 may represent a computing facility 214 of FIG. 2, or a part of a computing facility 214. The hardware unit 323 may include a computing machine. The term computing machine relates to any type or combination of computing devices, or computing-related units, including, but not limited to, a processing device, a memory device, a storage device, and/or a communication device.

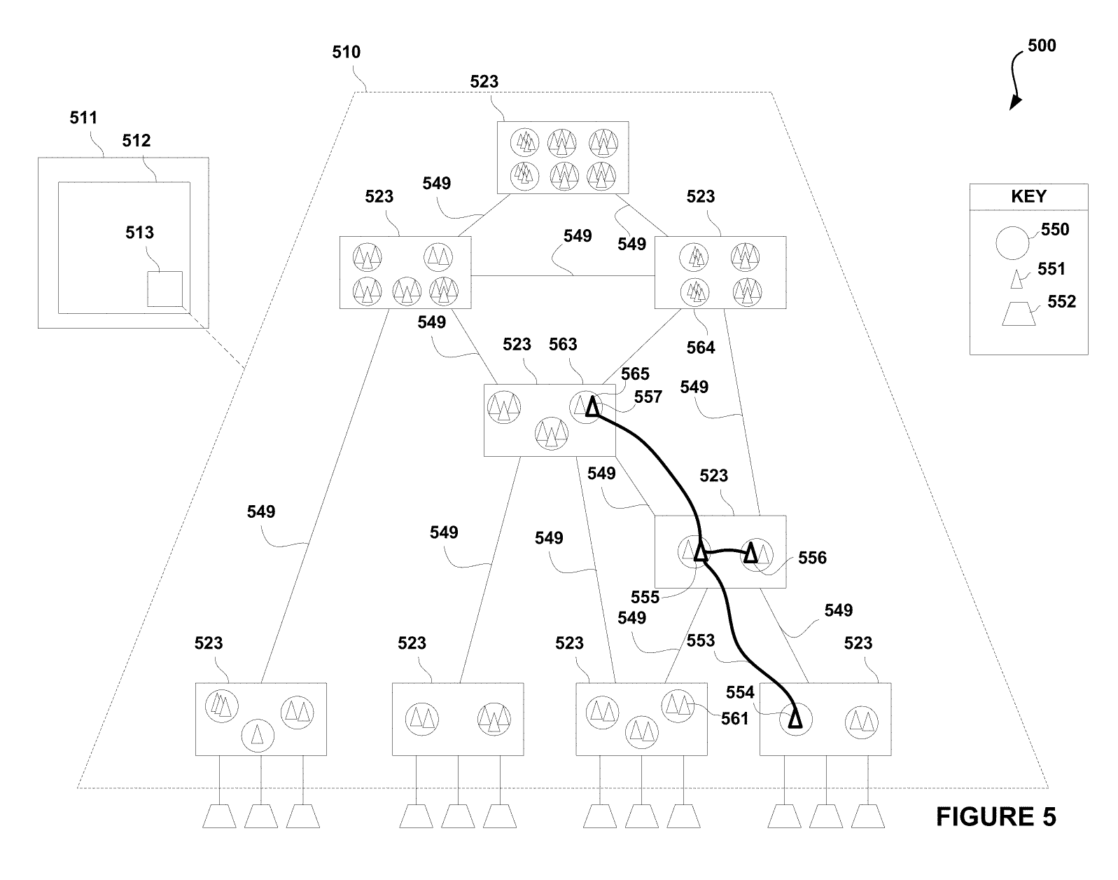

The hardware unit 323 may therefore be a network server, and the computing facility 214 may be a plurality of network servers, or a data-center, including cloud-based infrastructure. As an option, the hardware unit 323 may be implemented in the context of any of the devices of the NFV-based network 210 of FIG. 2 and/or FIG. 5 and in any desired communication environment.

Each hardware unit 323 (or computing machine, computing device, computing-related unit, and/or hardware component, etc.), including each communication link between such hardware units, may be associated with one or more performance type and a respective performance rating or value, where the hardware unit and/or communication link is operative to provide the performance value. Performance types are, for example, processing power, cash memory capacity, regular memory capacity (e.g. RAM, dynamic, or volatile memory, etc.), non-volatile memory (e.g. such as flash memory, etc.) capacity, storage capacity, power, cooling, bandwidth, bitrate, latency, jitter, bit error rate, and packet loss, etc. Virtual machines may run on top of the hardware unit 323 and a VNF may be run on one or more of such virtual machines.

The hardware unit 323 may be operative to provide computing infrastructure and resources for any type and/or instance of software component executed within the NFV-based network 210 of FIG. 2. In this regard, the hardware unit 323 may be operative to process any of the processes described herein, including but not limited to, any NFV-related software component and/or process. The hardware unit 323 is operative to process virtual network functions (VNFs), VNF instances, network function virtualization orchestration (NFV-O) software, modules and functions, data center management software, and/or cloud management systems (CMS), etc.

In various embodiments, the hardware unit 323 may include at least one processor unit 324, one or more memory units 325 (e.g. random access memory (RAM), a non-volatile memory such as a Flash memory, etc.), one or more storage units 326 (e.g. including a hard disk drive and/or a removable storage drive, representing a floppy disk drive, a magnetic tape drive, a compact disk drive, etc.), one or more communication units 327, one or more graphic processors 328 and displays 329, and one or more communication buses 330 connecting the various units/devices.

The hardware unit 323 may also include one or more computer programs 331, or computer control logic algorithms, which may be stored in any of the memory units 325 and/or storage units 326. Such computer programs, when executed, enable the hardware unit 323 to perform various functions (e.g. as set forth in the context of FIG. 1, etc.). The memory units 325 and/or the storage units 326 and/or any other storage are possible examples of tangible computer-readable media.

It is appreciated that computer program 331 may include any of the NFV management system 211, the NFV-O 212, and/or the license ledger module 213 of FIG. 2.

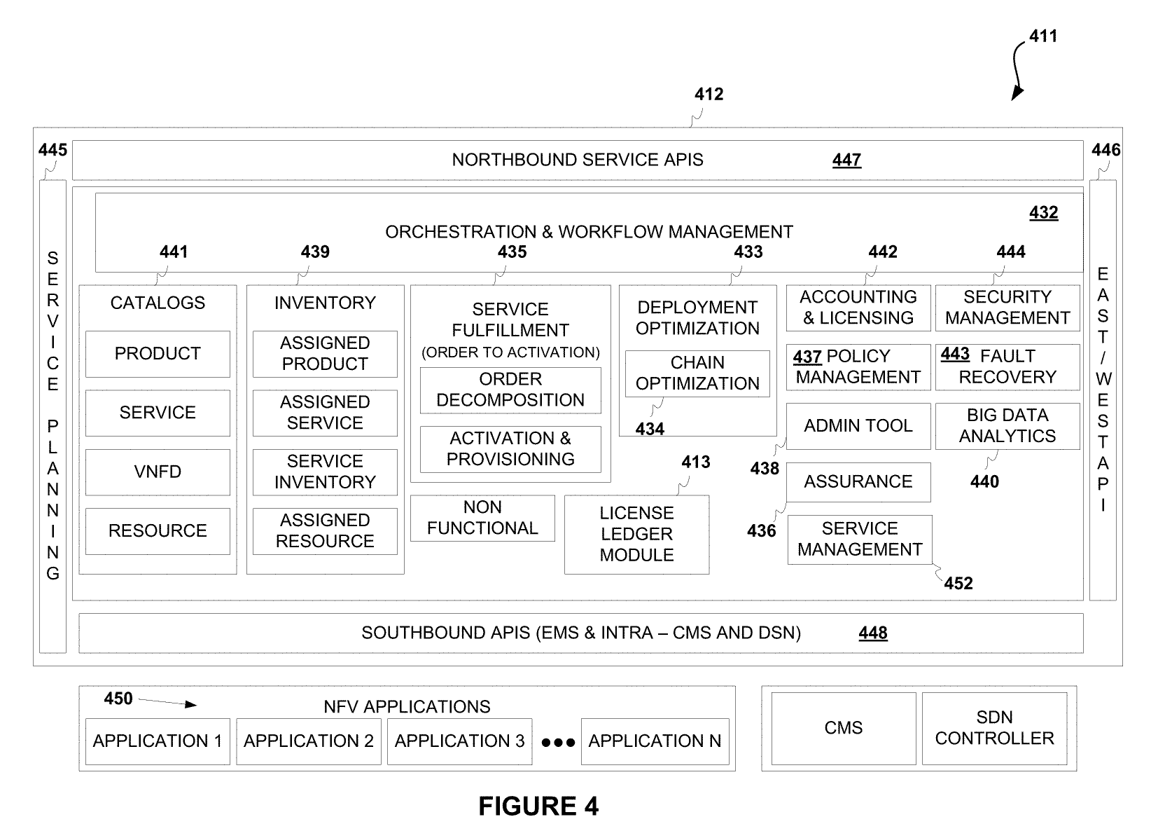

FIG. 4 illustrates a simplified diagram of an NFV management system 411, in accordance with one embodiment. As an option, the NFV management system 411 may be implemented in the context of the details of the previous Figures. For example, in one embodiment, the NFV management system 411 may represent the NFV management system 211 of FIG. 2. Of course, however, the NFV management system 411 may be implemented in the context of any desired environment. Further, the aforementioned definitions may equally apply to the description below.

In one embodiment, the NFV management system 411 may include an NFV-O module 412, and a license ledger module 413. The NFV management system 411 may include one or more NFV-O modules 412. In various embodiments, each of the NFV-O modules 412 may include orchestration and workflow management 432 that is responsible for managing (i.e. orchestrating) and executing all NFV-O processes, including inbound and/or outbound communication and interfaces.

The NFV management system 411 may include a deployment optimization module 433 that enables a user to devise automatic mechanisms for network optimizations. The deployment optimization module 433 may operate these mechanisms automatically and continuously to optimize the distribution of VNFs 450 and their VNF instances in real-time (or near-real-time) by migrating VNFs 450 and VNF instances (e.g. VNF instances 551 of FIG. 5, etc.) between hardware units (e.g. hardware units 551 of FIG. 5, etc.).

The NFV management system 411 may also include a chain optimization module 434. The chain optimization module 434 may be a part of deployment optimization module 433 and may enable a user to devise automatic mechanisms for optimizing the deployment of chains or groups of VNFs 450 and VNF instances. A service provided by an NFV-based network is typically made of a particular chain or group of particular VNFs 450 and their respective VNF instances. The chain optimization module 434 optimizes the deployment of chains or groups of services between hardware units according to the requirements and specifications associated with and/or adapted to the particular service, or chain, or a group.

The chain optimization module 434 may operate these mechanisms automatically and continuously to optimize in real-time the operation of chains or groups of the VNFs 450 and their VNF instances by re-planning their distribution among hardware units and optionally also by migrating the VNFs 450 and associated VNF instances between hardware units.

The NFV management system 411 may also include a service fulfillment module 435 that manages service and resource (e.g. VNF) instance lifecycle activities as part of the process and orchestration activities. This may include on boarding, initiation (e.g. instantiation), installation and configuration, scaling, termination, software update (e.g. of a running VNF, etc.), test environment, and/or rollback procedure. Additionally, the service fulfillment module 435 may also provide decomposition of an order to multiple network services, and the activation of such network service as a single VNF instance, or as a chain of VNF instances.

Order decomposition includes translating business orders into a network oriented service implementation plan. For example, a business order may be decomposed into a plurality of functions, some of which may be provided by different software programs or modules (e.g. such as various VNFs) instantiated as a plurality of VNF instances across one or more data centers. Performing order decomposition, the service fulfillment module 435 may consult the deployment optimization module 433 for the best deployment option to customer order in a given network and resource condition. Performing order decomposition, the service fulfillment module 435 may then initiate the service including all its components. Order decomposition may be performed in several locations across an NFV-O hierarchy. For example, initial decomposition may be performed in the root of the NFV-O, and then further decomposition may be performed in the relevant data centers.

In one embodiment, an activation and provisioning module may provide the plan for activation and provisioning of the service to the orchestration and workflow management 432. The activation and provisioning module may also provide feedback on fulfilment status to an upper layer. This upper layer may include the business support services (BSS).

The NFV management system 411 may also include an assurance module 436 and a service management module 452 capable of gathering real time data on network elements' status and creating a consolidated view of services and network health. The assurance module 436 includes assurance functionality and may interact with the service management module 452 to perform assurance related lifecycle management procedures. Lifecycle management can be also triggered by other modules, policies, manual intervention, or from the VNFs themselves, etc. The assurance module 436 and the service management module 452 may also trigger events associated with lifecycle management and faults. The assurance module 436 and the service management module 452 may monitor the health of the network and may execute fault recovery activities.

The assurance module 436 and the service management module 452 provide the ability to monitor services' status and performance according to the required criteria. The assurance module 436 and the service management module 452 may also interact with the network infrastructure (e.g. including computing, storage, and networking, etc.) to receive the required information, analyze the information, and act upon each incident according to the defined policy. The assurance module 436 and the service management module 452 are able to interact with analytics to enrich a policy assurance module. Interfaces may also be provided for implementation by an external system.

The NFV management system 411 may also include a policy management module 437 that enables a user to define and configure offline and/or real-time policy for controlling VNF and service related rules. The policy management module 437 may contain the preconfigured policies and activities as well as selection rules for the NFV-O process to determine the preferred policy or activity to be performed for a particular process event. The policy management may be multi-layered, including vendor policy, service policy, and operator policy, etc. The policy mechanism may trigger the suitable policy layer (vendor/service/operator).

The NFV management system 411 may also include an administration module 438 that provides an overall view of the network, manual lifecycle management and intervention, and manual system administration and configuration. The administration module 438 may be operable to enable a user such as an administrator (e.g. administrator 222 of FIG. 2, etc.) to manage, view, and operate the NFV-O system. The administration module 438 may also provide a view of the network topology and services, the ability to perform specific activities such as manual lifecycle management, and changing service and connectivity configuration.

The NFV management system 411 may also include an inventory management module 439 that maintains a distributed view of deployed services and hardware resources. Inventory catalogues may reflect the current instantiation and allocation of the resources and services within the network mapped into products and/or customer entities.

The NFV management system 411 may also include a big data analytics module 440 that analyzes network and service data to support network decisions involving services and subscribers to improve network performance based on actual usage patterns. The big data analytics module 440 may also generate what-if scenarios to support business-oriented planning processes. Additionally, the big data analytics module 440 may function to analyze and evaluate the information for various planning aspects (e.g. Virtual Network Capacity Planning, Data Center Capacity Planning, Value based planning, Cost analysis for network deployment alternatives, etc.), deployment and management (e.g. Guided Operator Recommendations, What-if scenario analysis and simulation, application rapid elasticity and resource usage optimization, etc.), and may support business-oriented planning processes.

The NFV management system 411 may also include a catalog module 441 may include records defining various aspects of the network, such as products, services, and resources such as hardware units and VNFs (e.g. a VNF directory, etc.). The catalog module 441 may include a collection of centralized, hierarchical information repositories containing resource, service and product definitions with their relationship, versioning, and/or descriptors, etc. Such records may include templates enabling a user, such as an administrator, to define particular network components such as resources, products, services, etc. A resource template may define resources descriptors, attributes, activities, procedures, and/or connectivity, etc. A service template may define a service variation from resource building blocks. A product template may define parameters of a sellable product (e.g. prices, rating, etc.) based on service composition (e.g. in one embodiment, this may be part of a BSS catalogue).

The inventory management module 439, the big data analytics module 440, and/or the catalog module 441 may support multiple data centers, multiple CMS s and provide a centralized view across the infrastructure. The inventory management module 439, the big data analytics module 440, and/or the catalog module 441 may also support hybrid networks and services maintaining both physical and virtual resources.

The NFV management system 411 may also include an accounting and licensing module 442 that may be operable to record and manage network software usage data for commercial purposes including licensing, accounting, billing, and reconciliation of services with subscribers and providers. The accounting and licensing module 442 may manage licensing and usage of virtual network applications, including the ability to support complex rating schemes, based on various parameters such as CPU, memory, data, etc. The accounting and licensing module 442 may enable users to define the pricing of particular VNF modules and provide settlement with vendors. The accounting and licensing module 442 may also enable the evaluation of internal costs of services provided within the network for calculating return on investment (ROI). In one embodiment, the license ledger module 413 may be a source of data to the accounting and licensing module 442. For example, the license ledger module 413 may communicate with the accounting and licensing module 442 to coordinate licensing/billing associated with VNFs, etc.

The NFV management system 411 may also include a fault recovery module 443 (otherwise named disaster recovery planning module or DRP, etc.) that enables a user to plan and manage disaster recovery procedures for the NFV-O and/or the entire network.

The NFV management system 411 may also include a security management module 444 that provides the authentication authorization and accounting services of application security across the network. The security management module 444 may include, for example, an authentication module and function. In one embodiment, the authentication module and function (e.g. including identity management, etc.) may authenticate the identity of each user defined in the system. Each user may have a unique user identity and password. The system may support password based authentication with flexible password policy. Integration with external authentication providers may be done via additional system enhancements. The authorization module and function may support a role-based access control (RBAC) mechanism, where each user is assigned with one or more roles according to the business needs based on the least privileges concept (e.g. standard or administrator roles). In one embodiment, the accounting and licensing module 442 may provide an audit of security events such as authentication or login events.

As an option, the security management module 444 may use rules to protect sensitive information. For example, such rules may be used to ensure the data accessed is used for the specific purposes for which it was collected, sensitive information is encrypted when in storage/transit and masked/truncated on display and logs, and that the entire security system is deployed in the customer's intranet network (i.e. behind network/infrastructure measures), in an independent domain, etc.

In one embodiment, the NFV management system 411 may further include a Secure Development Life Cycle (SDLC) module that ensures that security aspects are handled during a project's life cycle, such as security design, security testing, etc.

As shown further in FIG. 4, the NFV management system 411 may include a service planning module 445. The service planning module 445 may be used by a communication service provider (CSP) sales representative, enterprise, and/or technician, as part of selling engagement process with enterprise/SMB customers.

The service planning module 445 may also provide the ability to interact with catalogues, customer data, network and ordering systems to provide online network service proposals for the enterprise customers with ability to quote update the proposal, validate the serviceability and network inventory, and once done, provide the service order for activation using the northbound interface.

The license ledger module 413 may also be part of the NFV-O module 412. The license ledger module 413 is operable to: identify one or more usage transactions associated with one or more VNFs in the NFV-based network; store information associated with the usage transactions utilizing blockchain technology such that the information is unalterable; and communicate with one or more license reporters to provide access to usage data corresponding to the usage transactions (to provide a trusted source for real-time usage metrics, etc.). In one embodiment, the license ledger module 413 may communicate with the accounting and licensing module 442 to coordinate licensing/billing associated with VNFs, etc.

The NFV management system 411 may also include east/west APIs 446 that include various domains/activities interfaces, including an information source to a big data repository, and interaction capability with a physical network system (OSS).

Northbound APIs 447 provides application programming interfaces (APIs) to various external software packages, such as business support system (BSS) for service order fulfilment, cancel and update activities, status notification, resource inventory view, monitoring system, assurance system, service planning tool, administration tool for system view and configuration, and big data repository, etc.

Further, the southbound APIs 448 may provide APIs for external software packages, such as CMS (including service and VNFs lifecycle activities—receiving from the infrastructure status and monitoring information for upstream system and activities [e.g. assurance]), an SDN Controller (or other connectivity system) to configure inter and intra data center connectivity, an EMS to configure the VNF, and a VNF for a direct configuration.

FIG. 5 illustrates a simplified diagram 500 of a deployed NFV-based network 510, in accordance with one embodiment. As an option, the diagram 500 may be viewed in the context of the details of the previous Figures. For example, in one embodiment, the deployed NFV-based network 510 and associated elements may represent the NFV-based networks and associated elements described in the context of the previous Figures. Of course, however, the diagram 500 may be viewed in the context of any desired environment. Further, the aforementioned definitions may equally apply to the description below.

As shown in FIG. 5, the NFV-based network 510 may include hardware units 523 connected via transmission lines 549, and VNFs implemented as software programs 550 installed in hardware units 523. Some of the hardware units 523 may be directly connected to a customer. The customer may be a subscriber, an end-user, or an organization, represented herein as a terminal or a server 552, or a plurality of terminals and/or servers 552. The NFV-based network 510 may also include a NFV management system 511, an NFV-orchestration (NFV-O) 512, and a license ledger module 513 (which may all represent elements described in the context of the previous figures, etc.).

As shown further in FIG. 5, several, typically different, VNFs 550 may be installed in the same hardware unit 523. Additionally, the same VNF 550 may be installed in different hardware units 523.

A VNF 550 may be executed by a processor of the hardware unit 523 in the form of a VNF instance 551. Therefore, a particular VNF 550 installed in a particular hardware unit 523 may be “incarnated” in (e.g. initiated, executed as, etc.) any number of VNF instances 551. The VNF instances 551 may be independent of each other. Additionally, each VNF instance 551 may serve different terminals and/or servers 552. The NFV-based network 510 connects to and between communication terminal devices 552 that may be operated by one or more customers, subscribers, and/or end-users.

It is appreciated that a network operator may manage one or more services deployed in the customer's premises. Therefore, some of the hardware units 523 may reside within the premises of the network operator, while other hardware units 523 may reside in the customer's premises. Similarly, a server, such as server computer 216 of FIG. 2, may reside in the premises of the network operator or in the customer's premises. Consequently, when the network operator provides and/or manages one or more services for a customer's terminal devices 552 such as a server computer, the NFV-based network 510 of the network operator may directly manage the VNFs 550, providing the services and their VNF instances 551.

In such situation, the NFV-based network 510 may manage the services irrespectively of the location of the terminal devices 552 (e.g. the server computer 216, etc.), whether in the premises of the network operator or in the customer's premises. In other words, the NFV-based network 510 may be managing the VNFs 550 and the VNF instances 551 providing the services, as well as the terminal devices 552 (e.g. the server computer 216, etc.) being co-located within the same computing device (e.g. the hardware unit 523, etc.), whether in the premises of the network operator or in the customer's premises or in a commercial cloud or any other place.

A service provided by the communication network may be implemented using one or more VNFs. For example, the service may be a group, or a chain of interconnected VNFs. The VNFs making the group, or the service, may be installed and executed by a single processor, by several processors on the same rack, within several racks in the same data-center, or by processors distributed within two or more data-centers. In some cases, chain optimization may be employed by optimizing the deployment of a service in a communication network using network function virtualization, and to optimizing the deployment of a group, or a chain, of virtual network functions in the NFV-based network 510. Therefore, the term “chain optimization” refers to the planning and/or managing of the deployment of VNFs making a chain, or a group, of VNFs providing a particular service.

For example, FIG. 5 shows a first service 553, including the VNFs 550 and their respective VNF instances 554, 555, 556, and 557, and a thick line. In this example, the group or chain of the VNFs 550 making first service 553 are connected as a chain of VNFs 550. However, the VNFs 550 making a service may be connected in any conceivable form such as a star, tree-root, tree-branch, mesh, etc., including combinations thereof. It is noted that the VNFs 550 may be executed by two or more VNF instances 551, such as VNF 554.

The deployment of the group or chain of the VNFs 550 making the first service 553 is therefore limited by constraints such as the capacity of the communication link 549 bandwidth and/or latency (delay).

A VNF may have a list of requirements, or specifications, such as processing power, cash memory capacity, regular memory capacity (e.g. RAM, dynamic, or volatile memory, etc.), non-volatile memory (e.g. such as flash memory, etc.) capacity, storage capacity, power requirements, cooling requirements, etc. A particular VNF instance 551 providing a particular function (e.g. to a particular customer, entity, etc.) may have further requirements, or modified requirements, for example, associated with a particular quality of service (QoS) or service level agreement (SLA). Such requirements may include maximum latency or delay, average latency and maximum variance (latency jitter), maximal allowed packet loss, etc. Other requirements may include service availability, redundancy, backup, provisions for roll-back and/or recovery, fault-tolerance, and/or fail-safe operation, etc.

A service made of a chain or a group of VNFs 550 and their VNF instances 551 may have a similar list of requirements, or specifications, covering the service as a whole. Therefore, such requirements, or specifications, may imply, affect, or include, requirements, or specifications, regarding communication links between the VNFs 550 and/or the VNF instances 551. Such requirements, or specifications, may include bandwidth, latency, bit-error rate, and/or packet loss, etc. Such communication requirements or specifications may further impose deployment limitations, or constraints, requiring particular VNFs 550 and/or VNF instances 551 to reside in the same data-center, or within the same rack, or even in the same computing device, for example, sharing memory or being executed by the same processor. Security measures may add further requirements, or specifications, such as co-location of some of the VNFs 550 and/or the VNF instances 551.

In the context of FIG. 5, the NFV-based network 510 has a hierarchical structure. There may be at least four aspects of the hierarchical structure of the NFV-based network 510. The networking or traffic aspect refers to the arrangement of the transmission lines between the hardware units 523. The processing aspect refers to the arrangement of the hardware units 523. The software aspect refers to the arrangement of the VNFs 550. The operational aspect refers to the arrangement of the VNF instances 551.

One aspect of the optimization process in an NFV-based network is that it may be based on real-time needs, rather than long-term, statistically anticipated, needs. One potential limitation on network reconfiguration in NFV-based networks is that network configuration does not result in a deterioration beyond acceptable level of any of the current services. The NFV deployment module (e.g. module 433 of FIG. 4, etc.) may function to enable and manage migration of services between the hardware units 523, the VNFs 550, and the VNF instances 551 in real-time, without affecting or with a minimal effect on the availability of a service, and while securing service and session continuity.

In the context of the current description, the term “continuous” means that the deployment optimization module and/or a chain optimization module (e.g. the chain optimization module 434 of FIG. 4, etc.) performs the relevant optimization task or process in run-time, or real-time, or online, or on-the-fly, or repetitively and without adversely affecting the network's functionality and its services.

Unlike a legacy network, the NFV-based network may have two topologies: the topology of the hardware devices, and the topology of the VNFs (the distribution of VNFs among the hardware devices). The topology of the hardware network is relatively stable, while the VNF topology can be optimized in real-time. Another benefit of the NFV-based network is that modifying the software topology (e.g. the distribution of VNFs among the hardware devices) is much less costly than any modification of the hardware topology. However, any modification of the network has its cost, including the cost of making such modification possible. Added cost may result from the need to process the modification of the topology and the re-distribution of VNF instances and to maintain excess resources for such purpose.

Thus, in some cases, it may be desired to localize the NFV-O 512, and particularly the deployment optimization processes associated with the deployment optimization module and the chain optimization module to reduce the cost, and simultaneously to secure the possibility to expand the scope of the network managed by these processes, if needed.

Telecom Network Operators are moving to NFV based networks where rapid on-boarding of vendor provided VNFs raises difficult questions about usage licenses. Operators are looking to eliminate vendor provided license servers and to simplify the overall license process. Vendors are put in a situation where VNF usage is controlled and monitored by the operator without an independent means of usage verification.

The license ledger module 513 works in this NFV context to track VNF usage using blockchain technology such that both operators and vendors have a trusted source for real-time usage metrics. A license agent (e.g. in one embodiment, an open source license agent, etc.) is incorporated into each VNF by the vendor (or a third party, etc.) and sends metrics and life-cycle events to the license ledger module 513. The license ledger module 513 is built with blockchain technology (as is used with in digital currencies, etc.) to ensure that VNF usage is unalterable and thus a trusted source for all parties. A license reporter tool allows operators and vendors to access the usage data in the license ledger module 513 at any time with the scope of visibility controlled by encryption keys (i.e. each vendor may use their encryption key to see their usage data but all other usage data remains encrypted).

The ability to access VNF usage in real-time from a trusted source allows for new billing models such as per subscriber minute usage of a VNF or even reverse billing for infrastructure usage.

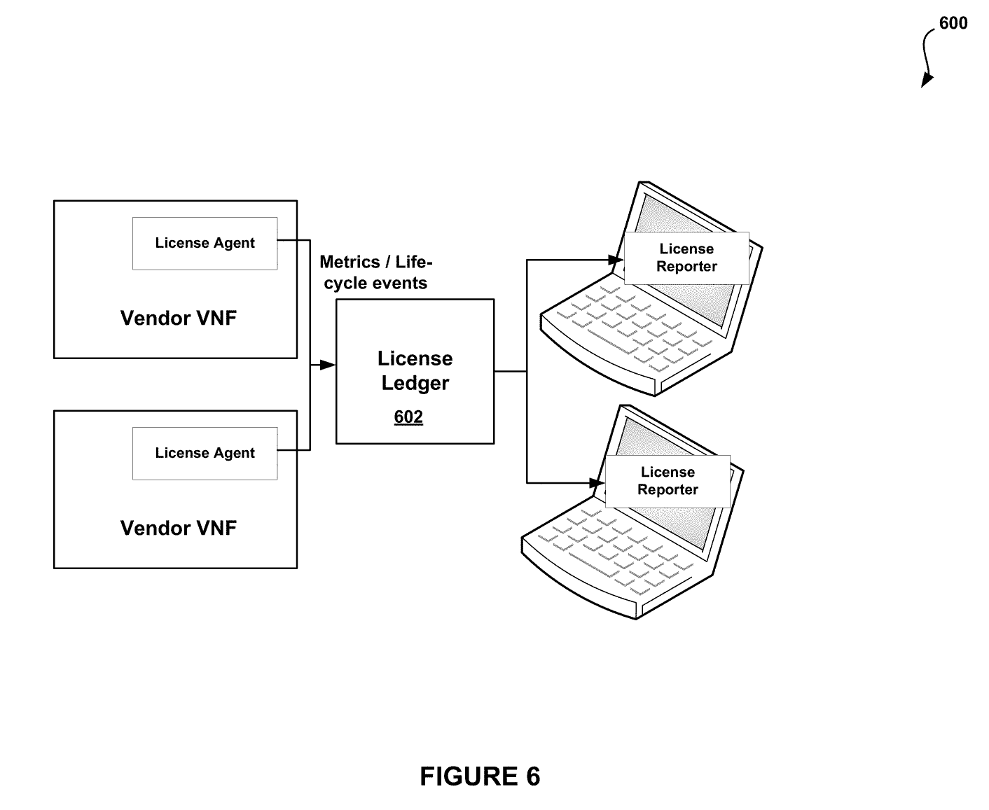

FIG. 6 illustrates a simplified diagram of a license ledger system architecture 600, in accordance with one embodiment. As an option, the architecture 600 may be implemented in the context of the details of the previous figures. Of course, however, architecture 600 may be implemented in the context of any desired environment. Further, the aforementioned definitions may equally apply to the description below.

The license ledger 602 uses blockchain technology to store usage transactions such that modification of the usage data is not possible. This characteristic is the primary reason why blockchain is the technology of choice for digital currencies, where the incentive to manipulate transactions is very strong.

Blockchain technology works on the concept that a block of transactions are grouped together (e.g. in a group ten minutes of transactions, etc.), encrypted and chained onto prior blocks. As new blocks are added (or mined), the computational work load required to alter a prior block becomes exponentially higher.

As VNF usage data may not necessarily be of interest to the public, the license ledger 602 may act as a private ledger and new blocks may be created by the same entity that hosts the ledger itself. Block size (or time duration) may be configurable to complete the chaining (e.g. within a few seconds, etc.), based on system settings.

Two primary application programming interfaces (APIs) may be presented by the license ledger 602 to other systems (e.g. both encrypted REST interfaces, etc.). A license agent API may receive new usage events (e.g. POST events, etc.) and record them while a license reporter API may receive requests for retrieval of usage reports (e.g. GET events, etc.). In this case, neither of these APIs would allow events to be deleted. In addition to the primary APIs, an operational and maintenance interface may be present for internal VNF management.

In various embodiments, the license ledger 602 may only record a pointer to the usage transactions, utilizing blockchain technology, which may actually be stored in a traditional secure database. In certain cases, this may have some performance advantages over storing all of the information in the ledger itself. In these cases, the license ledger 602 may only be used to ensure the validity of the license transactions.

The license ledger 602 may be a VNF and therefore may be deployable within the same NFV infrastructure that it is designed to help monitor.

The license agent is responsible for sending the license ledger 602 usage metrics and life-cycle events such that accurate usage reports can be generated (e.g. by the license ledger 602, etc.). In one embodiment, the link to the license ledger 602 may be a secure HTTPS protocol primarily transporting Key/Value pairs. The Key/Value pairs may include various types of information, including: common information such as a license identifier, operator and vendor identifiers, dates and times, etc.; usage metrics provided by the vendor that may include data such as the number of active subscribers being hosted by the VNF, the number of active sessions, the number of VMs in use, bandwidth, or any other metric that is appropriate; and VNF life-cycle events such as VNF creation, deletion, scaling, failure, etc. Accurate VNF life-cycle events allow for billing models that take into consideration the real-time usage of VMs, while dynamic VNF scaling operations take place.

The license agent may not be responsible for enabling or disabling usage of a VNF, rather just usage monitoring. As all parties have a trusted source for usage data, there is not necessarily a need to control individual VNF usage as with traditional methods. Additionally, if it is desired to use a VNF without using licenses (e.g. for a test deployment, etc.), the license agent may be disabled or not integrated into the VNF in the first place.

Each vendor and operator may access the data from the license ledger 602 to generate billing records or audit usage via the license reporter. The license reporter may use a secure HTTPS protocol link to request a list of transactions over a specified period or for a specified VNF. All transactions over this link may include an encrypted user identifier, which the license ledger 602 may use to validate the request, ensuring privacy between vendors (and possibly multiple operators, etc.). In one embodiment, the license reporter may be implemented as a web application such that no software is required to be installed by its users.

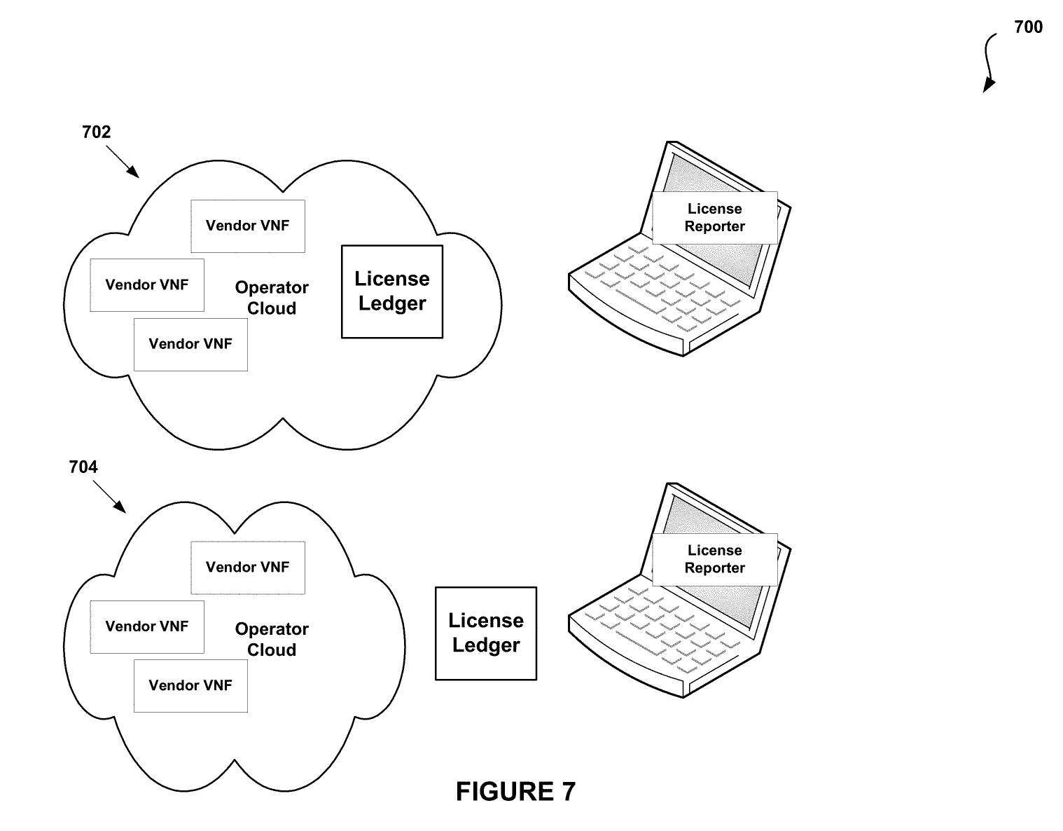

FIG. 7 illustrates a simplified diagram of two license ledger usage models 700, in accordance with one embodiment. As an option, the usage models 700 may be implemented in the context of the details of the previous figures. Of course, however, usage models 700 may be implemented in the context of any desired environment. Further, the aforementioned definitions may equally apply to the description below.

FIG. 7 shows two usage models for the license ledger including a license ledger hosted by an operator, shown in example 702, and a third party license ledger, shown in example 704. The operator hosting model 702 allows the operator to keep all of the usage metric transactions within their network. The third party hosting model 704 may be used by small operators who would like to outsource this part of the business to a trusted third party. Either use case has the ability to address concerns associated with current licensing systems.

To date, there is no single license management solution being utilized. Operators will often attempt to negotiate site wide licenses with vendors to avoid the management complexity of monitoring VNF usage. Unfortunately, this can result in either the operator or vendor being unsatisfied as usage can be higher or lower than expectations, thus leaving money on the table for one of the parties.

Alternatively, some VNFs may require a license key be used each time a VNF is instantiated. Installation and removal of such a key can be difficult to automate, thus violating one of the primary goals of NFV, and may result in operators not being able to fully use the licenses they have purchased.

Also, vendor provided license servers may be problematic to some operators as they require infrastructure resources (computation and connectivity) that are expensive in both capital and operation. Operators may also have security concerns with the introduction of proprietary systems in their networks.

Lastly, some operators expect vendors to use operational metrics that they collect for license purposes. This creates a potential trust conflict as the party providing the data (the operator) has an incentive to minimize reported usage.

The license ledger system described herein addresses these concerns, among others. Not only does the license ledger system described herein provide a trusted, independent source for usage metrics, it is also able to store and retrieve this data dynamically. Dynamic usage reports enable new billing paradigms such as cost per subscriber/minute or VM/hour. The license ledger system also enables new models where usage of the infrastructure is part of the cost equation (e.g. subscriber/minute—CPU/hour, etc.). By recording VNF life-cycle events (such as VNF failures), billing can take into consideration actual VNF operation times or even penalties for loss of service.

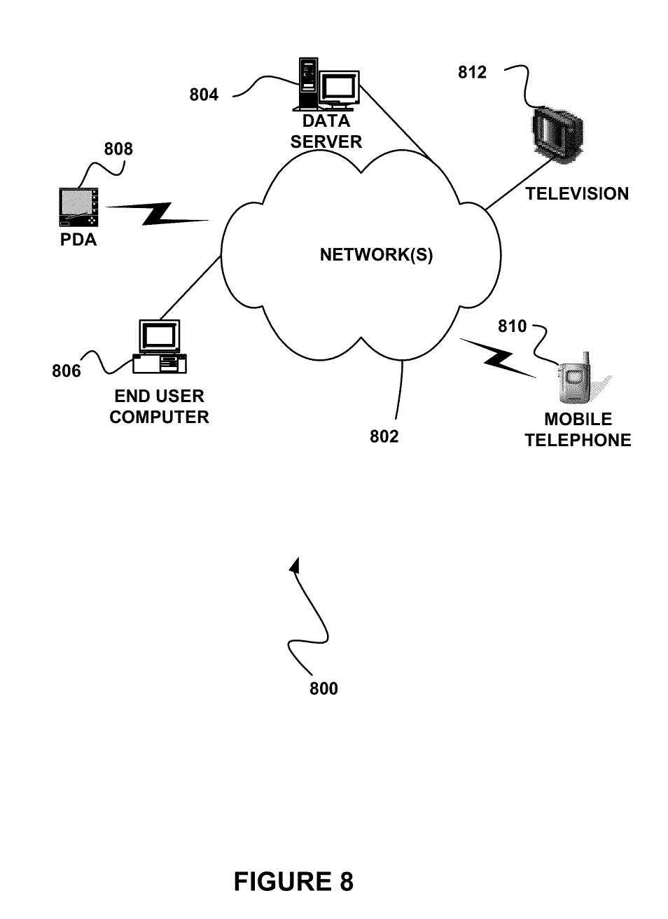

FIG. 8 illustrates a network architecture 800, in accordance with one possible embodiment. As shown, at least one network 802 is provided. In the context of the present network architecture 800, the network 802 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 802 may be provided.

Coupled to the network 802 is a plurality of devices. For example, a server computer 804 and an end user computer 806 may be coupled to the network 802 for communication purposes. Such end user computer 806 may include a desktop computer, lap-top computer, and/or any other type of logic. Still yet, various other devices may be coupled to the network 802 including a personal digital assistant (PDA) device 808, a mobile phone device 810, a television 812, etc.

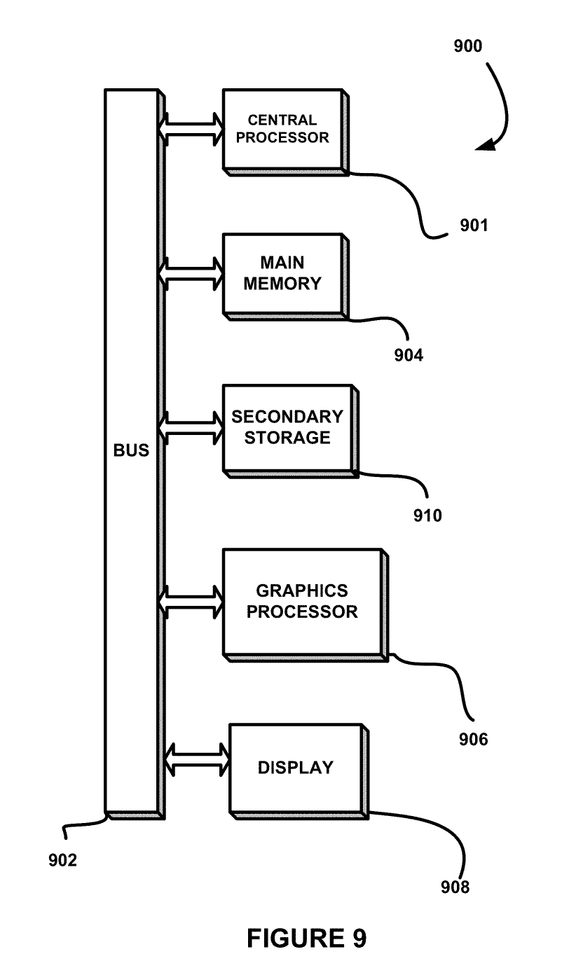

FIG. 9 illustrates an exemplary system 900, in accordance with one embodiment. As an option, the system 900 may be implemented in the context of any of the devices of the network architecture 800 of FIG. 8. Of course, the system 900 may be implemented in any desired environment.

As shown, a system 900 is provided including at least one central processor 901 which is connected to a communication bus 902. The system 900 also includes main memory 904 [e.g. random access memory (RAM), etc.]. The system 900 also includes a graphics processor 906 and a display 908.

The system 900 may also include a secondary storage 910. The secondary storage 910 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 904, the secondary storage 910, and/or any other memory, for that matter. Such computer programs, when executed, enable the system 900 to perform various functions (as set forth above, for example). Memory 904, storage 910 and/or any other storage are possible examples of tangible computer-readable media.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A non-transitory computer readable medium comprising computer code executable by a processor to perform a method comprising:
receiving, through a first application programming interface (API) from a plurality of virtual network functions (VNFs) located in a network function virtualization based (NFV-based) network and provided by a plurality of vendors, usage data for the VNFs, the usage data for each of the VNFs including:
an indication of an amount of usage of the VNF for one or more types of usage, an identifier of one of the vendors providing the VNF;
storing the usage data in a database that utilizes blockchain technology to ensure that the stored usage data is unalterable; and
providing, through a second API, the vendors with access to the stored usage data, including:
receiving, through the second API from one of the vendors, a request for a usage report for a specified one or more of the VNFs,
identifying an encrypted user identifier from the request,
validating the request using the encrypted user identifier identified from the request including determining that the specified one or more of the VNFs are each provided by the one of the vendors,
responsive to validating the request, generating the usage report from the usage data stored in the database and providing the vendor with the usage report.

2. (canceled)

3. (canceled)

4. (canceled)

5. (canceled)

6. The computer program product of claim 1, wherein each of the VNFs includes a license agent incorporated therein.

7. The computer program product of claim 6, wherein each of the license agents sends the usage data for its corresponding VNF through the first API.

8. (canceled)

9. (canceled)

10. The computer program product of claim 1, wherein the one or more types of usage include at least one of: a number of active subscribers being hosted by the VNF; a number of active sessions associated with the VNF; a bandwidth use associated with the VNF; a packet rate associated with the VNF; a number of ports associated with the VNF; a number of links associated with the VNF; a number of VPNs (virtual private networks) associated with the VNF; a number of routes associated with the VNF; memory usage associated with the VNF; CPU consumption associated with the VNF; a disk access rate associated with the VNF; storage volume associated with the VNF; a number of subtending clients or devices associated with the VNF; and a number of database tables associated with the VNF.

11. The computer program product of claim 1, wherein the usage data further includes life-cycle events associated with the VNF including at least one of: VNF creation information; VNF deletion information; VNF scaling information; and VNF failure information.

12. (canceled)

13. (canceled)

14. (canceled)

15. (canceled)

16. (canceled)

17. (canceled)

18. (canceled)

19. A method, comprising:
receiving, through a first application programming interface (API) from a plurality of virtual network functions (VNFs) located in a network function virtualization based (NFV-based) network and provided by a plurality of vendors, usage data for the VNFs, the usage data for each of the VNFs including:
an indication of an amount of usage of the VNF for one or more types of usage,
an identifier of one of the vendors providing the VNF;
storing usage data in a database that utilizes blockchain technology to ensure that the stored usage data is unalterable; and
providing, through a second API, the vendors with access to the stored usage data, including:
receiving, through the second API from one of the vendors, a request for a usage report for a specified one or more of the VNFs,
identifying an encrypted user identifier from the request,
validating the request using the encrypted user identifier identified from the request including determining that the specified one or more of the VNFs are each provided by the one of the vendors,
responsive to validating the request, generating the usage report from the usage data stored in the database and providing the vendor with the usage report.

20. A system comprising:
a memory system; and
one or more processing cores coupled to the memory system and that are each configured for:
receiving, through a first application programming interface (API) from a plurality of virtual network functions (VNFs) located in a network function virtualization based (NFV-based) network and provided by a plurality of vendors, usage data for the VNFs, the usage data for each of the VNFs including:
an indication of an amount of usage of the VNF for one or more types of usage,
an identifier of one of the vendors providing the VNF;
storing the usage data in a database that utilizes blockchain technology to ensure that the stored usage data is unalterable; and
providing, through a second API, the vendors with access to the stored usage data, including:
receiving, through the second API from one of the vendors, a request for a usage report for a specified one or more of the VNFs,
identifying an encrypted user identifier from the request,
validating the request using the encrypted user identifier identified from the request including determining that the specified one or more of the VNFs are each provided by the one of the vendors,
responsive to validating the request, generating the usage report from the usage data stored in the database and providing the vendor with the usage report.
